(19) United States
(12) Patent Application Publication
(10) Pub. No.: US 2024/0197006 A1
(43) Pub. Date: Jun. 20, 2024

(54) ATTACHMENT FOR MASK, ATTACHMENT KIT FOR MASK, AND MASK EQUIPPED WITH ATTACHMENT

(71) Applicant: Ishikawa Wire Netting Co., Ltd., Tokyo (JP)

(72) Inventor: Yukio Ishikawa, Tokyo (JP)

(73) Assignee: Ishikawa Wire Netting Co., Ltd., Tokyo (JP)

(21) Appl. No.: 18/565,209

(22) PCT Filed: Jun. 1, 2022
(86) PCT No.: PCT/JP2022/022301

§ 371 Date: Nov. 29, 2023

(30) Foreign Application Priority Data
Jun. 1, 2021 (JP) 2021-092196

(51) Int. Cl. A41D 13/11

(52) U.S. Cl. CPC A41D 13/1161; A41D 13/1115

(57) ABSTRACT

Provided is an attachment for a mask (attachment (3)) structured to attach an outer face mask (copper mesh (2)), to the outside of an inner face mask (face mask 4) having a pair of ear-loop cords (4a), the attachment (3) having a cord insertion part (slit (3d)) through which each cord (4a) is allowed to pass for attachment to the face mask (4), and a mounting part (mesh mounting part (3a)) onto which the copper mesh (2) is mounted.

### TECHNICAL FIELD

The present invention relates to an attachment for a mask, an attachment kit for a mask, and a mask equipped with an attachment.

### BACKGROUND ART

Recent global pandemic of new coronavirus has increased awareness of virus infection prevention, and has disseminated a variety of face masks for suppressing saliva from being scattered, and droplets of body fluid such as saliva from adhering to facial mucous membrane.

For example, Patent Document 1 discloses a pocketed non-woven mask, which is a face mask having antibacterial and antiviral effects, used with a copper mesh plate enclosed and zipped in the pocket.

### CITATION LIST

### Patent Document

[Patent Document 1] JP 3230247 U

### SUMMARY OF THE INVENTION

### Problem to be Solved by the Invention

The face mask disclosed in Patent Document 1, however, needs to be a nonwoven mask with a pocket and a zipper, so that without such accessories, the face mask has been difficult to wear on face, with the copper mesh plate attached thereto.

The present invention was conceived in consideration of the issue. It is therefore an object of the present invention to provide an attachment for a mask that makes a face mask easily wearable on face: an attachment kit for the mask having the mask attachment and a metal fabric; and a mask equipped with attachment having the attachment for the mask and an outer face mask.

### Means for Solving the Problem

The attachment for the mask of the present invention is an attachment for a mask structured to attach an outer face mask, to the outside of an inner face mask having a pair of ear-loop cords, the attachment for the mask includes: a cord insertion part through which each cord is allowed to pass for attachment to the inner mask, and a mounting part onto which the outer face mask is mounted.

The attachment kit for the mask has a pair of the attachments for the mask, and a sheet-like flat metal fabric having a warp-forming metal wire as the warp, and a weft-forming metal wire as the weft, the metal fabric has fold lines indicated thereon, and the metal fabric is structured to form a pleated outer face mask, upon folded along the fold lines.

The mask equipped with attachment specifically has a pair of the attachments for the mask, and the outer face mask.

### Effects of the Invention

The present invention can provide an attachment for the mask that makes an outer face mask and an inner face mask easily wearable on face; an attachment kit for the mask having the attachment for the mask and a metal fabric; and a mask equipped with attachment having the attachment for the mask and an outer face mask.

### BRIEF DESCRIPTION OF DRAWINGS

FIG. 1 is an explanatory drawing illustrating a mask equipped with attachment according to an embodiment viewed from the side, as attached to an inner face mask.

FIG. 2 is a front view illustrating the attachment as opened.

FIG. 3 is a side elevation illustrating the attachment of FIG. 2, viewed from the side.

FIG. 4 is a front elevation illustrating the outer face mask before folded.

### DESCRIPTION OF EMBODIMENTS

Embodiments of the present invention will be explained below referring to the attached drawings. Note that all similar constituents in all drawings will have the same reference signs to properly skip the explanation as appropriate.

Note that the drawings referred in this embodiment merely exemplify structure, shape, and arrangement of the individual constituents of the attachment for the mask, the attachment kit for the mask, and the mask equipped with attachment of the present invention, without limiting the present invention.

Also note that the drawings do not always necessarily depict exact dimensional relations among the length, width and height of the attachment for the mask, the attachment kit for the mask, and the mask equipped with attachment.

The metal wire in the context herein means a metal wire used for weaving the metal fabric, and includes a metal filament and twisted wire having a plurality of metal monofilaments twisted therein. The metal wire includes those having a constitutive metal of the metal wire exposed, and those having at least a part of the outer circumference coated.

### Overview

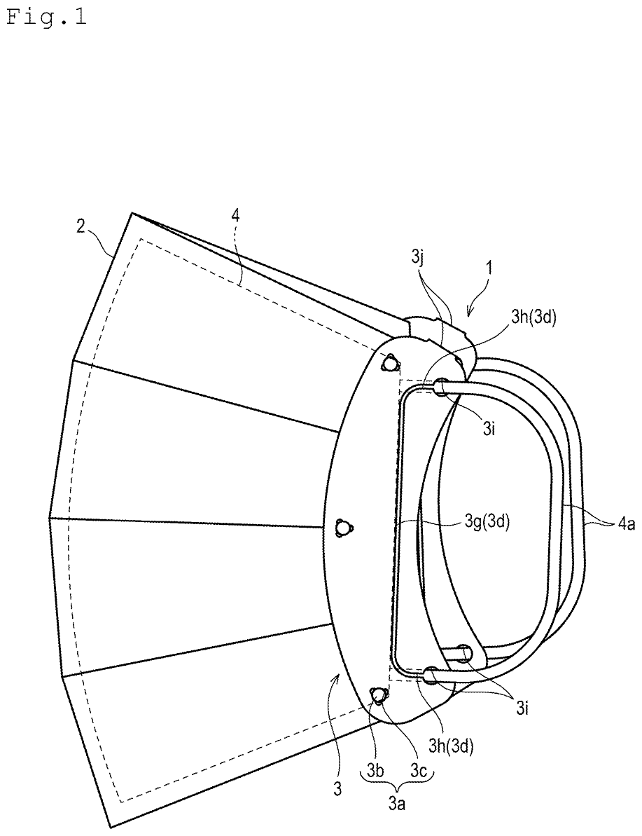

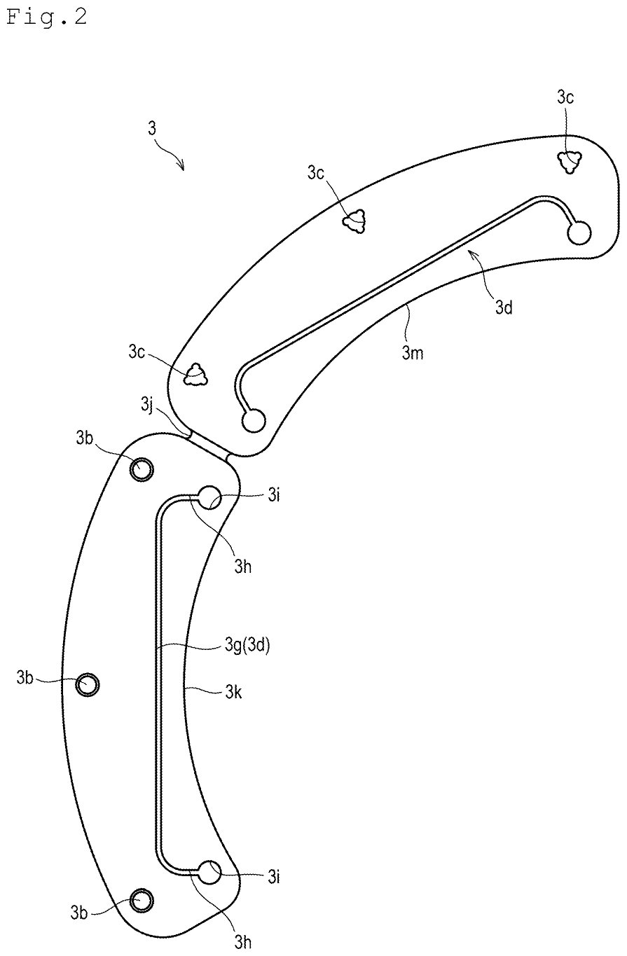

First, an overview on an attachment 3, an attachment kit 1X for the mask, and a mask equipped with attachment 1 of this embodiment will be overviewed, mainly referring to FIGS. 1 and 2. FIG. 1 is an explanatory drawing illustrating the mask equipped with attachment 1 according to the embodiment viewed from the side, as attached to an inner face mask (face mask 4). FIG. 2 is a front view illustrating the attachment for the mask (attachment 3) as opened.

The attachment for the mask (attachment 3) of this embodiment is aimed at attaching an outer face mask (copper mesh 2), to the outside of the inner face mask (face mask 4) having a pair of ear-loop cords 4a.

The attachment 3 specifically has a cord insertion part (slit 3d) through which each cord is allowed to pass for attachment to the inner mask, and a mounting part (mesh mounting part 3a, see FIG. 1) onto which the copper mesh 2 is mounted.

The attachment for the mask (attachment 3), thus structured to have the cord insertion part (slit 3d) and the mounting part (mesh mounting part 3a), enables easy wearing on face of an article having the outer face mask (copper mesh 2) attached to the outside of the inner face mask (face mask 4).

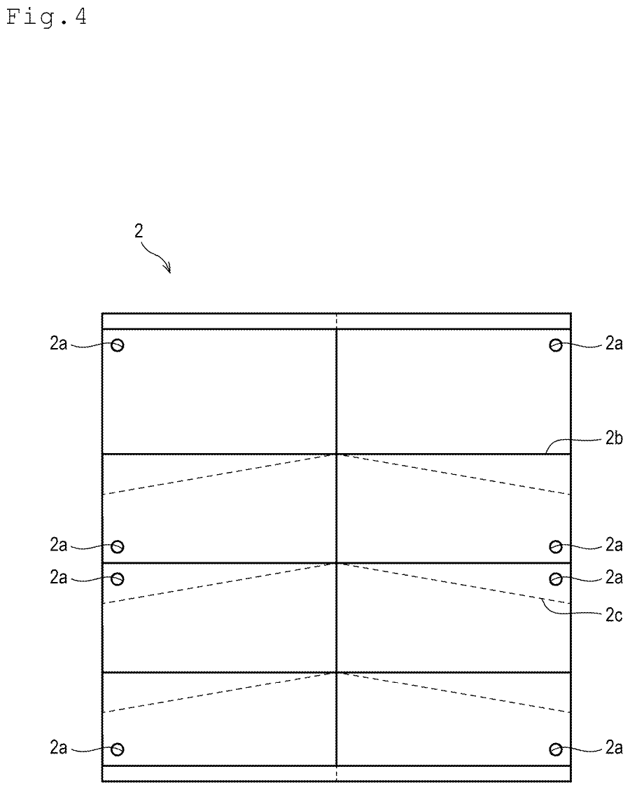

The attachment kit 1X for the mask of this embodiment has a pair of the attachments for the mask (attachments 3), and a sheet-like flat metal fabric having an unillustrated warp-forming metal wire as the warp, and an unillustrated weft forming metal wire as the weft (copper mesh 2, see FIG. 4).

The copper mesh 2 has fold lines (mountain fold lines 2b and valley fold lines 2c, see FIG. 4) indicated thereon, and is structured to form a pleated outer face mask (copper mesh 2), upon folded along the fold lines (mountain fold lines 2b and valley fold lines 2c).

The mask equipped with attachment 1 is specifically composed of a pair of attachments for the mask (attachments 3), and the outer face mask (face mask 4).

Such structure enables to enjoy the effect of the attachment 3, also in the forms of the attachment kit 1X and the mask equipped with attachment 1.

### [Overall Structure]

Next, an overall structure will be explained, mainly referring to FIG. 1.

As has been described previously, the mask equipped with attachment 1 has the attachment 3 to be attached to the face mask 4, and the outer face mask (copper mesh 2) to be attached to the attachment 3.

The mask equipped with attachment 1 is used typically for a case where an antibacterial and antiviral outer face mask (copper mesh 2) is additionally attached to the face mask 4; for a case where the outer face mask with high droplet filtration efficiency is additionally attached to the face mask 4 with low droplet filtration efficiency; and for a case where an aesthetic outer face mask is additionally attached.

### [Attachment]

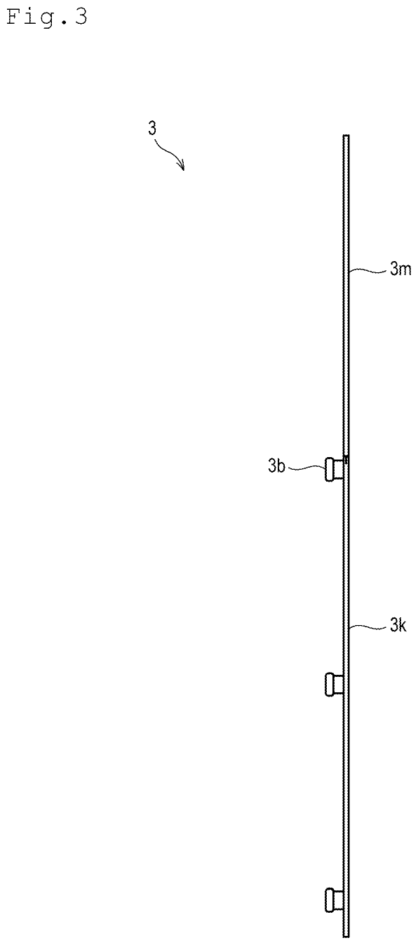

Next, the attachment 3 will be explained mainly referring to FIG. 3, in addition to FIGS. 1 and 2. FIG. 3 is a side elevation illustrating the attachment 3 in FIG. 2, viewed from the side face.

The attachment 3 has a first strip 3k that contacts with the outer face of the inner face mask 4 (face mask 4) when the mask 4 is attached, and a second strip 3m that is overlaid onto the first strip 3k.

The attachment 3 also has the cord insertion part (slit 3d) through which each cord 4a of the face mask 4 is allowed to pass for attachment to the face mask 4, and a mounting part (mesh mounting part 3a) onto which the copper mesh 2 is mounted.

The cord insertion part (slit 3d) is formed at least either in the first strip 3k or the second strip 3m. The mounting part (mesh mounting part 3a) clamps the outer face mask (copper mesh 2), upon overlaying of the first strip 3k and the second stripe 3m.

With the first strip 3k and the second strip 3m provided thereto, and thus structured to clamp the outer face mask (copper mesh 2) between the strips, the attachment 3 can more stably mount thereon the outer face mask (copper mesh 2).

Either one of the first strip 3k and the second strip 3m (first strip 3k in this embodiment) has formed thereon protrusions 3b that protrude towards the other one (the second strip 3m in this embodiment) upon overlaying of the first strip 3k and the second strip 3m.

The other one, out of the first strip 3k and the second strip 3m, has formed therein fitting holes 3c that fit the protrusions 3b.

In more detail as illustrated in FIG. 3, each protrusion 3b in this embodiment is composed of a cylindrical base and a disk-like end with a larger diameter, thus shaped like a mushroom so as not to fall off from the fitting hole 3c. There are three protrusions 3b individually formed on a face of the first strip 3k opposed to the second strip 3m, so as to protrude towards the second strip 3m. On the first strip 3k, the center protrusion 3b, out of the three protrusions 3b, is arranged more distant from a virtual straight line that includes the vertical slit 3g, than the other protrusions 3b are.

Each fitting hole 3c in this embodiment has, when viewed normal to the opening, has an outer edge in which a contour of a round hole is combined with three arcs each having a radius of curvature smaller than that of the round hole, which are arranged at a pitch of 120 degrees along the circumference of the round hole so as to protrude out from the round hole. The fitting holes 3c are formed so as to pierce the second strip 3m. In the second strip 3m, the center fitting hole 3c, out of the three fitting holes 3c, is arranged more distant from a virtual straight line that includes the vertical slit 3g, than the other fitting holes 3c are.

The three protrusions 3b and the three fitting holes 3c are arranged at positions at which they are correspondingly overlaid, when the attachment 3 is folded while centered on the foldback part 3j so as to overlay the first strip 3k and the second strip 3m. Although two or more protrusions 3b and two or more fitting holes 3c are preferably provided individually on the top side and the bottom side, the number and the shape of these components are freely selectable.

Each of the first strip 3k and the second strip 3m is arched like a bow when viewed normal to the plane. The slit 3d is formed closer to the lesser curvature side of the arched first strip 3k and the second strip 3m, meanwhile, the protrusions 3b or the fitting holes 3c are formed closer to the greater curvature side.

With such structure, fitting of the protrusions 3b and the fitting holes 3c can keep overlaying of the first strip 3k and the second strip 3m, thus maintaining stable clamping of the copper mesh 2 by the first strip 3k and the second strip 3m.

The protrusions 3b are fitted on the fitting holes 3c, while allowed to pass through the through-holes 2a formed in the copper mesh 2, thereby tightly holding the copper mesh 2 between the first strip 3k and the second strip 3m, which will be detailed later in the description on the outer face mask (copper mesh 2).

The attachment of the present invention is not limited to such structure, instead allowing any other structure so long as the copper mesh 2 is attachable thereto, such as being formed of a single strip, rather than the structure having the first strip 3k and the second strip 3m.

Also the “mounting part” is not limited to such article structured to mount the outer face mask (copper mesh 2) by clamping a part thereof, with the protrusions 3b and the fitting hole 3c fitted to each other. For example, the mounting part may alternatively be structured to mount a cloth-made outer face mask with use of a hook-and-loop fastener, or to mount a metal outer face mask (copper mesh 2) with use of a magnet, or to mount an outer face mask with use of an adhesive or a pressure adhesive.

As illustrated in FIG. 2, the cord insertion part (slit 3d) in this embodiment is formed in each of the first strip 3k and the second strip 3m.

The slits 3d are formed so as to be aligned, upon overlaying of the first strip 3k and the second strip 3m.

It is particularly preferred that the slits 3d formed in each of the first strip 3k and the second strip 3m are formed so as to be exactly aligned, upon overlaying of the first strip 3k and the second strip 3m. This structure makes it convenient to pass the cord 4a through the slits 3d individually formed in the first strip 3k and the second strip 3m, and to keep the cord 4a at round holes 3i, which is a predetermined position described later.

The present invention is, however, not limited to this structure. The slit 3d formed in the first strip 3k and the slit 3d formed in the second strip 3m are not always necessarily aligned exactly, so long as the slits 3d can allow the cord 4a to pass therethrough, alternatively allowing a structure in which the slits 3d overlap at least partially.

This structure can properly keep overlaying of the first strip 3k and the second strip 3m, by allowing the cord 4d to pass through the cord insertion part (slit 3d) of the first strip 3k and the cord insertion part (slit 3d) of the second strip 3m, while the first strip 3k and the second strip 3m are overlaid, and by hooking the cord 4a on the ears.

The attachment 3 has a foldback part 3j structured to integrally connect the first strip 3k and the second strip 3m, and to be foldable. The foldback part 3j is less rigid than the first strip 3k and the second strip 3m. Although the foldback part 3j in this embodiment has a cross-sectional area smaller than those of the first strip 3k and the second strip 3m, thus making it less rigid due to small moment of inertia, such low rigidity may alternatively be given with use of a material having a Young's modulus smaller than that of the first strip 3k and the second strip 3m.

With the attachment 3 thus provided with the foldback part 3j, this structure makes it easier to align the first strip 3k and the second strip 3m to a design position (more specifically, a position where the cord insertion parts (slits 3d) can align, or a position where the protrusions 3b and the fitting holes 3c can align). This also improves the parts manageability.

The attachment 3 will be paired and attached to the left and right sides of the copper mesh 2, wherein the pair of attachments 3 may be formed in the same shape. The pair of attachments 3 formed in the same shape will enjoy improved manageability. In this case, the pair of attachments 3 arranged on the left and right sides of the copper mesh 2 will be given by a combination of them having the foldback parts 3j placed on the upside and the downside.

Alternatively, the pair of attachments 3 may be formed symmetrically. With this structure, the pair of attachments 3 arranged on the left and right sides of the copper mesh 2 will have the foldback parts 3j equally placed on the vertical direction, thus equalizing the direction of flapping.

This enables the user to detach the copper mesh 2 from the pair of attachments 3, quickly without making mistakes.

Each cord insertion part (slit 3d) has a vertical slit 3g that extends along the outer edge of the outer face mask (copper mesh 2), and a lateral slit 3h that extends from each of both ends of the vertical slit 3g in one direction orthogonal thereto.

The “outer edge of the outer face mask” means each of the side edges positioned at the left and right sides of the face mask. A “vertical slit 3g that extends along the outer edge of the outer face mask” may be understood, in other words, that the vertical slit 3g extends in a direction more closer to the direction the outer edge lies, than to the direction orthogonal to the outer edge of the outer face mask (copper mesh 2).

With the vertical slit 3g thus structured, the cord 4a may be allowed to pass therethrough while kept stretched vertically (upwards and downwards), making hooking of the inner face mask (face mask 4) on the ears easier.

Passing of the cord 4a of the face mask 4 through the lateral slits 3h can suppress the cord 4a from causing displacement in the vertical (up-and-down) direction.

Moreover, the lateral slit 3h has, at the end thereof, a cord holding part (round hole 3i) having a size larger than the width of the lateral slit 3h.

The width of the lateral slit 3h means the length of the lateral slit 3h measured in the direction orthogonal to the direction the lateral slit 3h extends, on the plane of the first strip 3k or the second strip 3m.

The “cord holding part” may only hold the cord 4a within a predetermined area, and may alternatively have a polygonal hole for example, without being limited to the round hole 3i in this embodiment.

With the cord 4a of the face mask 4 allowed to pass through the cord holding part (round hole 3i) thus formed, the cord 4a may be prevented from causing displacement in the direction the lateral slit 3h extends (left-and-right) direction.

### [Outer Face Mask]

Next, the outer face mask (copper mesh 2) in this embodiment will be explained mainly referring to FIG. 4. FIG. 4 is a front elevation illustrating the outer face mask (copper mesh 2) before folded. FIG. 4 indicates the mountain fold lines 2b with solid lines, and the valley fold lines 2c with broken lines.

The copper mesh 2 (metal fabric) made of pure copper, which is an outer face mask in this embodiment, demonstrates antibacterial and antiviral effects through ionization.

The outer face mask (copper mesh 2) is a sheet-like flat metal fabric having an unillustrated warp-forming metal wire as the warp, and an unillustrated weft-forming metal wire as the weft. More specifically, each of the warp-forming copper wire and the weft-forming copper wire has an average wire diameter of 0.03 mm or larger and 0.09 mm or smaller.

Since being composed of the metal fabric (copper mesh 2), the outer face mask will have an improved shape retainability. In particular, the outer face mask made of copper or titanium is preferred, since the antibacterial and antiviral properties will be improved.

The “outer face mask”, although having no need of cord, may have the cord. The outer face mask in this embodiment is composed of the copper mesh 2 made of pure copper, which is a material different from cloth or non-woven fabric that composes the inner face mask (face mask 4), and is therefore preferred in terms of antibacterial and antiviral properties.

The present invention is, however, not limited to such structure, alternatively allowing that the outer face mask is made of the same material as the inner face mask 4. For example, a rectangular cloth sheet, which is highly aesthetic and breathable, and has the through-holes 2a (see FIG. 4) formed at four corners, may be used as the outer face mask. Alternatively, a plurality of kinds of cloth sheet having different design properties may be prepared, and any selected one of them may be mounted on the attachment 3.

The copper mesh 2 in this embodiment is formed of a 150-mm square shape before being folded along the mountain fold lines 2b indicated by solid lines in FIG. 4, and along the valley fold lines 2c indicated by broken lines. The copper mesh 2 is, however, not limited to such structure, and may alternatively be formed of a 130-mm or 180-mm square sheet, or may be formed of a rectangular or other polygonal sheet.

Material that composes the outer face mask, besides pure copper, is exemplified by copper, aluminum, nickel, titanium, gold, silver, platinum, iron, zinc, tin, lead, and alloys of these metals.

More specifically, a metal material that composes the warp-forming metal wire is preferably any one selected from the group consisting of copper (pure copper), copper alloy, aluminum alloy, stainless steel and titanium. Also a metal material that composes the weft-forming metal wire is preferably any one selected from the aforementioned group.

The copper alloy usable here includes brass, red brass, phosphor bronze, cupronickel and gold-copper alloy. Since red brass and brass look gold, and stainless steel looks silver, so that use of these metal material can make the outer face mask particularly aesthetic.

The metal fabric may have an exposed base made of the warp-forming metal wire and the weft-forming metal wire, or may have a print over the entire or a partial surface of the fabric. The printing may be given by a variety of means, which is typically color printing with use of an ink jet printer.

The mask equipped with attachment is composed of a laterally arranged pair of the attachments for the mask (attachments 3), and the outer face mask (copper mesh 2).

As illustrated in FIG. 4, the copper mesh 2 in this embodiment has the through-holes 2a through which the protrusions 3b formed on the first strip 3k are inserted. The mounting part (mesh mounting part 3a) is structured to fix the copper mesh 2, upon fitting of the protrusions 3b, after inserted through the through-holes 2a of the copper mesh 2, on the fitting holes 3c.

With the through-holes 2a, through which the protrusions 3b are inserted, formed on the outer face mask (copper mesh 2), the structure can further stabilize the mounting of the copper mesh 2 onto the attachment 3.

In the attachment kit 1X for the mask in this embodiment, the metal fabric (copper mesh 2) has indicated thereon the fold lines (mountain fold lines 2b and valley fold lines 2c). The metal fabric is structured to form a pleated outer face mask (copper mesh 2), upon folded along the mountain fold lines 2b and the valley fold lines 2c.

That is, in the attachment kit 1X, the outer face mask (copper mesh 2) in the initial stage is in the form of flat sheet, which is not mountable onto the attachment 3.

The copper mesh 2 before folded and the attachment 3 may be provided in a set (attachment kit 1X). Alternatively, the outer face mask (copper mesh 2) preliminarily pleated and the attachment 3 may be provided separately in the set. Alternatively, the outer face mask (copper mesh 2) preliminarily pleated may be provided with the attachment 3 attached thereto. Still alternatively, it may be provided even with the inner face mask (face mask 4) attached thereto as illustrated in FIG. 1.

As a result of pleating by folding by the user along the mountain fold lines 2b and the valley fold lines 2c, the copper mesh 2 will now allow eight through-holes 2a to accommodate a total of six protrusions 3b provided to the left and right attachments 3.

Among the through-holes 2a in this embodiment, two pairs of the holes at the center in the up-and-down (vertical) direction are arranged so as to individually aligned upon folding of the copper mesh 2.

Note the various constituents of the attachment for the mask, the attachment kit for the mask and the mask equipped with attachment of the present invention are not always necessarily independent from each other, instead allowing for example that a plurality of constituents is integrated into a single component, that a single constituent is composed of a plurality of components, that a certain constituent forms a part of other constituents, and that a certain constituent shares a part thereof with a part of other constituent.

This embodiment encompasses the technical spirits below.

(1)

An attachment for a mask structured to attach an outer face mask, to the outside of an inner face mask having a pair of ear-loop cords, the attachment for the mask includes:
a cord insertion part through which each cord is allowed to pass for attachment to the inner mask, and
a mounting part onto which the outer face mask is mounted.
   (2)

The attachment for the mask according to (1), wherein the cord insertion part has a vertical slit that extends along the outer edge of the outer face mask.

(3)

The attachment for the mask according to (2), wherein the cord insertion part has a lateral slit that extends from each of both ends of the vertical slit in one direction orthogonal thereto.

(4)

The attachment for the mask according to (3), wherein the lateral slit has, at the end thereof, a cord holding part having a size larger than the width of the lateral slit.

(5)

The attachment for the mask according to any one of (1) to (4), further including a first strip that contacts with the outer face of the inner face mask upon attachment of the inner face mask, and a second strip that is overlaid onto the first strip,
the cord insertion part is formed at least either in the first strip or the second strip, and
the mounting part clamps the outer face mask, upon overlaying of the first strip and the second strip.
   (6)

The attachment for the mask according to (5), wherein the cord insertion part is formed in each of the first strip and the second strip, and
the cord insertion parts individually formed in the first strip and the second strip are designed to align, upon overlaying of the first strip and the second strip.
   (7)

The attachment for the mask according to (5) or (6), wherein either one of the first strip and the second strip has formed thereon a protrusion that protrudes towards the other upon overlaying of the first strip and the second strip, and the other has formed therein a fitting hole that fits the protrusion.

(8)

The attachment for the mask according to any one of (5) to (7), further including a foldback part structured to integrally connect the first strip and the second strip, and to be foldable.

(9)

An attachment kit for a mask including:
a pair of the attachments for the mask described in any one of (1) to (8), and
a sheet-like flat metal fabric having a warp-forming metal wire as the warp, and a weft-forming metal wire as the weft,
the metal fabric has fold lines indicated thereon, and
the metal fabric is structured to form a pleated outer face mask, upon folded along the fold lines.
   (10)

A mask equipped with attachment including:
a pair of the attachments for the mask described in any one of (1) to (8); and
the outer face mask.
   (11)

The mask equipped with attachment according to (10), wherein the outer face mask is made of a sheet-like flat metal fabric having a warp-forming metal wire as the warp, and a weft-forming metal wire as the weft.

(12)

A mask equipped with attachment including a laterally arranged pair of the attachments for the mask described in (7); and
the outer face mask,
the outer face mask having a through-hole through which the protrusion is inserted, and
the mounting part being structured to fix the outer face mask, upon fitting of the protrusion, after inserted through the through-hole of the outer face mask, on the fitting hole.

This application claims priority to Japanese Patent Application No. 2021-92196 filed on Jun. 1, 2021, the entire contents of which are incorporated by reference herein.

### REFERENCE SIGNS LIST

1 mask equipped with attachment
1X attachment kit (attachment kit for mask)
2 copper mesh (outer face mask, metal fabric)
28 through-hole
2b mountain fold line (fold line)
2c valley fold line (fold line)
3 attachment (attachment for mask)
3a mesh mounting part (mounting part)
3b protrusion
3c fitting hole
3d slit (cord insertion part)
3g vertical slit
3h lateral slit
3i round hole (cord holding part)
3j foldback part
3k first strip
3m second strip
4 face mask (inner face mask)
4a cord

1. An attachment for a mask structured to attach an outer face mask, to the outside of an inner face mask having a pair of ear-loop cords, the attachment for the mask comprising:
a cord insertion part through which each cord is allowed to pass for attachment to the inner mask, and
a mounting part onto which the outer face mask is mounted.

2. The attachment for the mask according to claim 1, wherein the cord insertion part has a vertical slit that extends along the outer edge of the outer face mask.

3. The attachment for the mask according to claim 2, wherein the cord insertion part has a lateral slit that extends from each of both ends of the vertical slit in one direction orthogonal thereto.

4. The attachment for the mask according to claim 3, wherein the lateral slit has, at the end thereof, a cord holding part having a size larger than the width of the lateral slit.

5. The attachment for the mask according to claim 1, further comprising a first strip that contacts with the outer face of the inner face mask upon attachment of the inner face mask, and a second strip that is overlaid onto the first strip,
the cord insertion part is formed at least either in the first strip or the second strip, and
the mounting part clamps the outer face mask, upon overlaying of the first strip and the second strip.

6. The attachment for the mask according to claim 5, wherein the cord insertion part is formed in each of the first strip and the second strip, and
the cord insertion parts individually formed in the first strip and the second strip are designed to align, upon overlaying of the first strip and the second strip.

7. The attachment for the mask according to claim 5, wherein either one of the first strip and the second strip has formed thereon a protrusion that protrudes towards the other upon overlaying of the first strip and the second strip, and the other has formed therein a fitting hole that fits the protrusion.

8. The attachment for the mask according to claim 5, further comprising a foldback part structured to integrally connect the first strip and the second strip, and to be foldable.

9. An attachment kit for a mask comprising:
a pair of the attachments for the mask described in claim 1, and
a sheet-like flat metal fabric having a warp-forming metal wire as the warp, and a weft-forming metal wire as the weft,
the metal fabric has fold lines indicated thereon, and
the metal fabric is structured to form a pleated outer face mask, upon folded along the fold lines.

10. A mask equipped with attachment comprising:
a pair of the attachments for the mask described in claim 1; and
the outer face mask.

11. The mask equipped with attachment according to claim 10, wherein the outer face mask is made of a sheet-like flat metal fabric having a warp-forming metal wire as the warp, and a weft-forming metal wire as the weft.

12. A mask equipped with attachment comprising a laterally arranged pair of the attachments for the mask described in claim 7; and
the outer face mask,
the outer face mask having a through-hole through which the protrusion is inserted, and
the mounting part being structured to fix the outer face mask, upon fitting of the protrusion, after inserted through the through-hole of the outer face mask, on the fitting hole.
